(19) United States
(12) Patent Application Publication
(10) Pub. No.: US 2010/0149904 A1
(43) Pub. Date: Jun. 17, 2010

(54) MIXING DEVICE

(76) Inventors: Taku Ohi, Greer, SC (US); Kenneth M. Brazell, Piedmont, SC (US); Robert E. McCracken, Anderson, SC (US); Ryan T. Harrison, Anderson, SC (US); William S. Miller, Anderson, SC (US); Steve Steadings, Seneca, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/638,432

(22) Filed: Dec. 15, 2009

Related U.S. Application Data
(60) Provisional application No. 61/122,466, filed on Dec. 15, 2008.

(51) Int. Cl. B01F 9/10; B01F 11/00

(52) U.S. Cl. 366/118; 366/249

(57) ABSTRACT

A mixing device includes a housing, a motor supported by the housing, and an agitator operably coupled to the motor. The mixing device also includes a clamping mechanism operable to secure the housing to an open end of a container. The clamping mechanism includes a backing member engageable with an interior surface of a container, and a movable clamping member engageable with an exterior surface of the container, such that a wall of the container may be grasped or secured between the backing member and the movable clamping member. The mixing device also includes an actuator coupled to the housing and movable between a first position in which the movable clamping member is biased to engage the exterior surface of the container, and a second position in which the movable clamping member is disengaged from the exterior surface of the container, against the bias of the clamping member.

### RELATED APPLICATIONS

This application claims priority to co-pending U.S. Provisional Patent Application No. 61/122,466 filed on Dec. 15, 2008, the entire contents of which is incorporated herein by reference.

### FIELD OF THE INVENTION

The present invention relates to mixing devices, and more particularly to powered mixing devices.

### BACKGROUND OF THE INVENTION

Mixtures are often required to be stirred or agitated prior to their use. For example, paint or drywall compound is often stirred prior to application to homogenize the mixture. Agitators, including a shank and one or more blades coupled to the shank, are often used with conventional power tools (e.g., a hand-held drill) to stir mixtures such as paint or drywall compound in a container. Typically, the shank of an agitator is secured to the chuck of the hand-held drill in a conventional manner, and an operator inserts the agitator blade or blades into the mixture in a container (e.g., a 5-gallon bucket). The operator may then depress the drill trigger to initiate stirring of the mixture, while manually orbiting the agitator within the container to more thoroughly agitate to mixture.

### SUMMARY OF THE INVENTION

The invention provides, in one aspect, a mixing device including a housing, a motor supported by the housing, and an agitator operably coupled to the motor. The mixing device also includes a clamping mechanism operable to secure the housing to an open end of a container. The clamping mechanism includes a backing member engageable with an interior surface of a container, and a movable clamping member engageable with an exterior surface of the container, such that a wall of the container may be grasped or secured between the backing member and the movable clamping member. The mixing device also includes an actuator coupled to the housing and movable between a first position in which the movable clamping member is biased to engage the exterior surface of the container, and a second position in which the movable clamping member is disengaged from the exterior surface of the container, against the bias of the clamping member.

The invention provides, in another aspect, a mixing device including a housing, a motor supported by the housing, and an agitator operably coupled to the motor. The mixing device also includes at least one telescoping support with which the housing is positioned above an open end of a container.

The invention provides, in yet another aspect, a mixing device including a base, a radial arm supported by the base, a motor supported by the radial arm, and an agitator operably coupled to the motor. The base includes an arcuate recess within which a portion of a container is received, and the mixing device further includes a strap wrapped about at least a portion of the outer periphery of the container to secure the container within the arcuate recess of the base.

Other features and aspects of the invention will become apparent by consideration of the following detailed description and accompanying drawings.

### BRIEF DESCRIPTION OF THE DRAWINGS

FIG. 1 is an exploded perspective view of a container and a mixing device according to one construction of the invention.

FIG. 2 is a front perspective view of the mixing device of FIG. 1 attached to the container.

FIG. 3 is an exploded perspective view of a container and a mixing device according to another construction of the invention.

FIG. 4 is a front perspective view of the mixing device of FIG. 3 attached to the container.

FIG. 5 is a front view of the mixing device of FIG. 3, illustrating an agitator according to one construction of the invention.

FIG. 6 is a front view of the mixing device of FIG. 3, illustrating an agitator according to another construction of the invention.

FIG. 7 is a front perspective view of a container and a mixing device according to yet another construction of the invention.

FIG. 8 is a front perspective view of a container and a mixing device according to still another construction of the invention.

FIG. 9 is a rear perspective view of the mixing device of FIG. 8.

FIG. 10 is a perspective view of another construction of a mixing device of the invention.

FIG. 11 is a side view of a portion of the mixing device of FIG. 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

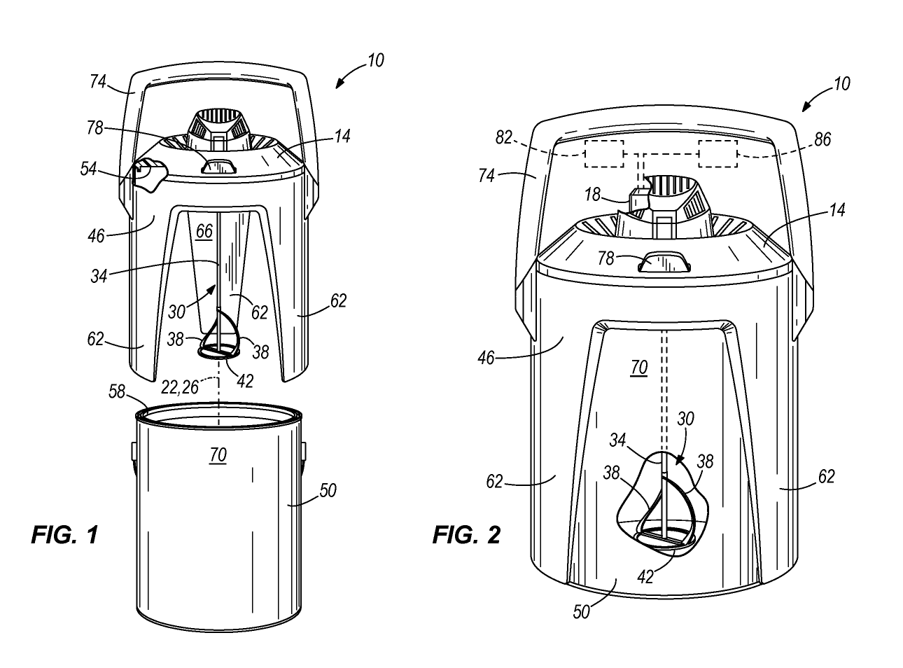

FIGS. 1 and 2 illustrate a mixing device 10 according to one construction of the invention. The mixing device 10 includes a housing 14 and a motor 18 (e.g., an electric motor; FIG. 2) supported within the housing 14. The motor 18 may receive electrical power from a remote power source via an electrical cord (not shown), or the motor 18 may receive electrical power from an onboard power source (e.g., a battery). Should a battery be used to provide electrical power to the motor 18, the mixing device 10 may include a charging circuit within the housing 14 to recharge the battery via the cord and a remote power source (e.g., household line current). Alternatively, the motor 18 may be configured to operate using a different power source (e.g., using a pressurized gas, a pressurized fluid, etc.). The motor 18 includes an output shaft (not shown) having an axis of rotation 22 coaxial with a central axis 26 of the housing 14.

The mixing device 10 also includes an agitator 30 coupled for rotation with the output shaft of the motor 18. The agitator 30 may be directly coupled to the output shaft of the motor 18 in any of a number of different ways (e.g., using fasteners, using an interference fit, etc.). Alternatively, a transmission or a gearbox may be positioned between the output shaft of the motor 18 and the agitator 30 to decrease the rotational speed of the agitator 30 or increase the amount of torque transferred to the agitator 30. Such a transmission or gearbox may be configured to position the agitator 30 in a location offset from the central axis 26 of the housing 14. Such a transmission or gearbox may also be configured to impart an orbital motion to the agitator 30 about the central axis 26 of the housing 14, in addition to rotating the agitator 30 about its axis.

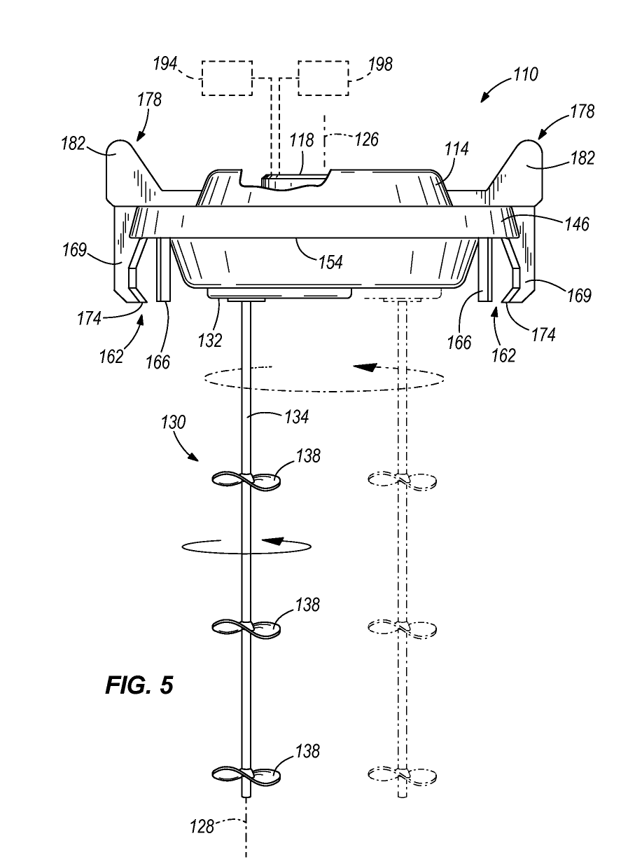

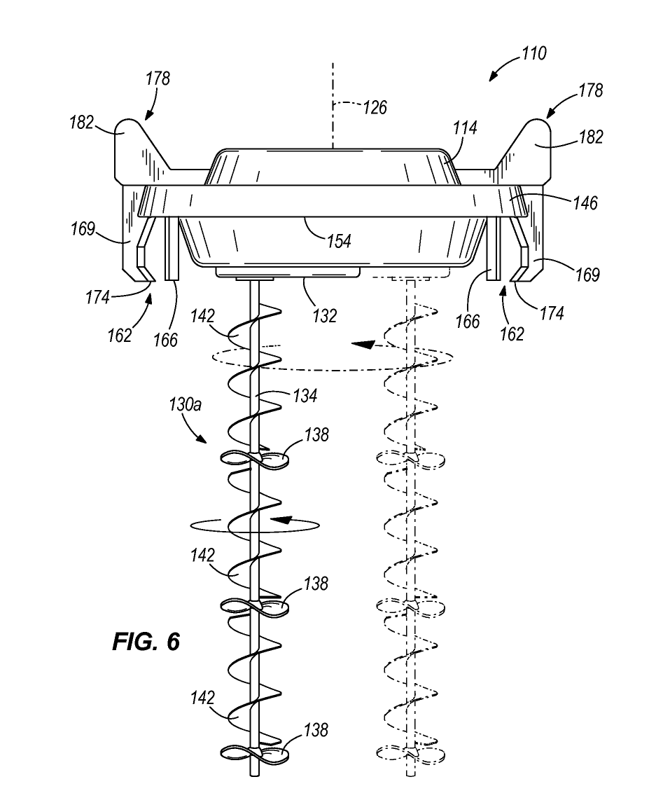

With continued reference to FIGS. 1 and 2, the agitator 30 includes a shaft 34, a plurality of blades 38 extending from the shaft 34, and a hoop 42 coupled to the shaft 34 to provide support to the blades 38. The illustrated agitator 30 includes two blades 38. Alternatively, the agitator 30 may be configured in any of a number of different ways, and may include a different number of blades 38 extending from the shaft 34. For example, the agitator 30 may be configured in a similar manner as the agitator shown in FIGS. 5 and 6.

With continued reference to FIGS. 1 and 2, the mixing device 10 also includes a mount 46 coupled to the housing 14 to rotationally and axially secure the housing 14 to a mixture-carrying container 50. The mount 46 may be coupled to the housing 14 in any of a number of different ways (e.g., by overmolding the housing 14, by integrally forming with the housing 14, by fastening to the housing 14, etc.). The illustrated container 50 is configured as a 1-gallon, cylindrical paint container 50. Alternatively, the container 50 may be configured with a larger or smaller internal volume, and may contain any of a number of different mixtures. The combination of the mount 46 and the housing 14 defines a recess or a receptacle 54 in which an open end 58 of the container 50 is received when the mixing device 10 is attached to the container 50 (FIG. 1), thereby allowing the housing 14 and the mount 46 to cover or seal the open end 58 of the container 50 to substantially prevent spilling of the mixture outside of the container 50 as the mixture is stirred by the agitator 30.

With reference to FIG. 1, the mount 46 includes a plurality of arms 62 extending from the housing 14 in a direction substantially parallel with the central axis 26 of the housing 14. Each of the arms 62 includes an inner peripheral surface 66 having a curvature defined by a radius centered on the central axis 26 of the housing 14. The inner peripheral surface 66 of each of the arms 62 is frictionally engageable with an outer peripheral surface or an exterior surface 70 of the container 50 to secure the container 50 between the arms 62 (FIG. 2). More particularly, each of the arms 62 is resiliently flexible, such that the arms 62 are capable of applying a radially inwardly-directed (i.e. normal) force on the container 50 relative to the central axis 26 of the housing 14 when the arms 62 are deflected from their natural or assumed positions. Such normal forces create the frictional forces between the inner peripheral surface 66 of each of the arms 62 and the exterior surface 70 of the container 50.

As shown in FIGS. 1 and 2, each of the arms 62 has a length about equal to the height of the container 50 to allow frictional forces to develop between the mixing device 10 and the container 50 substantially along the entire height of the container 50. Alternatively, the arms 62 may be differently sized (e.g., shorter, but wider) without substantially changing or reducing the amount of total contact area between the inner peripheral surfaces 66 of the arms 62 and the exterior surface 70 of the container 50. To provide elasticity or resilient flexibility in the arms 62, the arms 62 may be made entirely from a single elastic material (e.g., an elastomer), or the arms 62 may incorporate a reinforcing member (e.g., a strip of spring steel) embedded within a flexible outer covering.

The mixing device 10 further includes a handle 74 coupled to the mount 46. More particularly, the handle 74 is pivotably coupled to opposite sides of the mount 46 to provide an inverted, substantially U-shaped configuration to the handle 74 to facilitate transport of the mixing device 10 and the container 50, if one is attached to the mixing device 10. Alternatively, the handle 74 may be pivotably coupled to the housing 14, fixed to the mount 46, or the handle 74 may be configured in any of a number of different ways besides the illustrated inverted, substantially U-shaped configuration to provide for different ways of carrying or transporting the mixing device 10 and the container 50.

With continued reference to FIGS. 1 and 2, the mixing device 10 includes a switch 78 configured to electrically connect the motor 18 and the power source (e.g., household line current or a battery) to activate or energize the motor 18 to drive the agitator 30. The switch 78 may be configured as a manually actuated, two-position switch or a momentary switch to allow a user to manually operate the agitator 30 for an indefinite period of time at a fixed or predetermined rotational speed. Alternatively, the switch 78 may be configured as a variable resistor including a dial that is manually positioned by the user to set the rotational speed of the motor 18 and the agitator 30 between a predetermined minimum value (e.g., zero) and a predetermined maximum value.

In addition, the mixing device 10 may include a timer switch (not shown) electrically connected to the switch 78 in a parallel arrangement to allow the user to limit the time of operation of the motor 18 and the agitator 30. For example, the timer switch may include a dial that is manually positioned by the user to set the time of operation of the mixing device 10 between a predetermined minimum value (e.g., one minute) and a predetermined maximum value (e.g., 10 minutes). Any of a number of different increments of time may be employed by the timer switch and any of a number of time increments may be employed by the timer switch. As a further alternative, the timer switch may be employed without the switch 78, such that the mixing device 10 may not be operated indefinitely.

The illustrated mixing device 10 also includes a circuit 82 in electrical communication with the motor 18 that is configured to cycle the operation of the motor 18 (and therefore the agitator 30) according to one or more predetermined mixing cycles. Such mixing cycles may be paired with particular types of mixtures (e.g., paint, concrete, etc.) to ensure optimal mixing for each type of mixture. The circuit 82 may also include an interlock to override the cycling of the motor 18 after an initial mixing process is completed, whether based upon a timer or manual operation by a user.

To use the mixing device 10 illustrated in FIGS. 1 and 2, a user would first insert the open end 58 of the container 50 between the distal ends of the respective arms 62 and push the mixing device 10 downwardly over the container 50, thereby causing the arms 62 to outwardly deflect as the mixing device 10 is pushed downwardly. The mixing device 10 is pushed downwardly until the open end 58 of the container 50 is positioned in the receptacle 54 and covered by the mount 46, thereby sealing the mixture within the container 50. When the container 50 is fully received within the mixing device 10, the arms 62 clamp onto the container 50. In other words, the arms 62 apply a sufficient radially inwardly-directed force to develop a frictional force between the inner peripheral surfaces 66 of the arms 62 and the exterior surface 70 of the container 50 that exceeds the weight of the mixture and the container 50. This allows the mixing device 10 and the container 50 to be carried as a unit without substantial concern of the container 50 being unintentionally released from the mixing device 10.

After the mixing device 10 is attached to the container 50, the user energizes the motor 18 to drive the agitator 30 by actuating the switch 78 to complete the circuit between the motor 18 and the power source (e.g., household line current or a battery). In a configuration of the mixing device 10 including a two-position switch, the user would toggle the switch to a closed position to energize the motor 18 and drive the agitator 30 to initiate stirring of the mixture. To cease stirring of the mixture, the user would toggle the two-position switch to an open position to de-energize the motor 18 and stop the agitator 30. Alternatively, in a configuration of the mixing device 10 including a momentary switch, the user would toggle or depress the momentary switch, against a spring bias, to a closed position to energize the motor 18 and drive the agitator 30 to initiate stirring of the mixture. Then, to cease stirring of the mixture, the user would release the toggle or button to allow the spring bias to return the momentary switch to an open position to de-energize the motor 18 and stop the agitator 30.

Further, in a configuration of the mixing device 10 including a separate timer switch in parallel with the switch 78 or in lieu of the switch 78, the user would set the dial of the timer switch to the particular desired operating time, and then release the dial to energize the motor 18 and drive the agitator 30 to initiate stirring of the mixture. At the conclusion of the set operating time, the timer switch would open circuit between the motor 18 and the power source to de-energize the motor 18 and stop the agitator 30.

After mixing is complete, the user removes the mixing device 10 from the container 50 by grasping the distal or free ends of the respective arms 62 and pulling or peeling them outwardly away from the exterior surface 70 of the container 50, thereby separating or disengaging the inner peripheral surfaces 66 of the arms 62 and the exterior surface 70 of the container 50. As the respective surfaces 66, 70 of the arms 62 and the container 50 are disengaged, the frictional force between the arms 62 and the container 50 is reduced, thereby allowing the container 50 to be removed from the mixing device 10.

The mixing device 10 also includes a vibration device 86 (FIG. 2) to facilitate removing mixture clinging to the agitator 30 after the mixing device 10 is removed from the container 50. Although the vibration device 86 is shown incorporated with the motor 18, the vibration device 86 may be a separate and distinct component from the motor 18 that is coupled to the housing 14 and that is activated separately from the motor 18. In operation of the mixing device 10 after the device 10 is removed from the container, the vibration device may be activated or turned on for a period of time to vibrate the agitator 30 (without rotating the agitator 30) to shake loose any mixture clinging to the agitator 30. The device 10 may be maintained above the open end 58 of the container 50 to allow the mixture to return to the container 50. Like the motor 18, operation of the vibration device may be timed or may be indefinite based upon user input. Alternatively, the vibration device 86 may be utilized while the agitator 30 is submerged in the material to facilitate removal of any air bubbles, etc. trapped in the material.

To clean the mixing device 10, the user would attach the mixing device 10 to a container of cleaning solution or solvent, having a similar size as the paint container 50, in a similar manner as described above. The user would then actuate the switch 78 or timer switch to energize the motor 18 and drive the agitator 30 to initiate cleaning of the agitator 30 and the portions of the housing 14 and mount 46 exposed to the open end 58 of the container 50 when the mixing device 10 is attached to the container 50 (e.g., the receptacle 54). After cleaning is complete, the user would then remove the mixing device 10 from the container of cleaning solution or solvent in the same manner as described above.

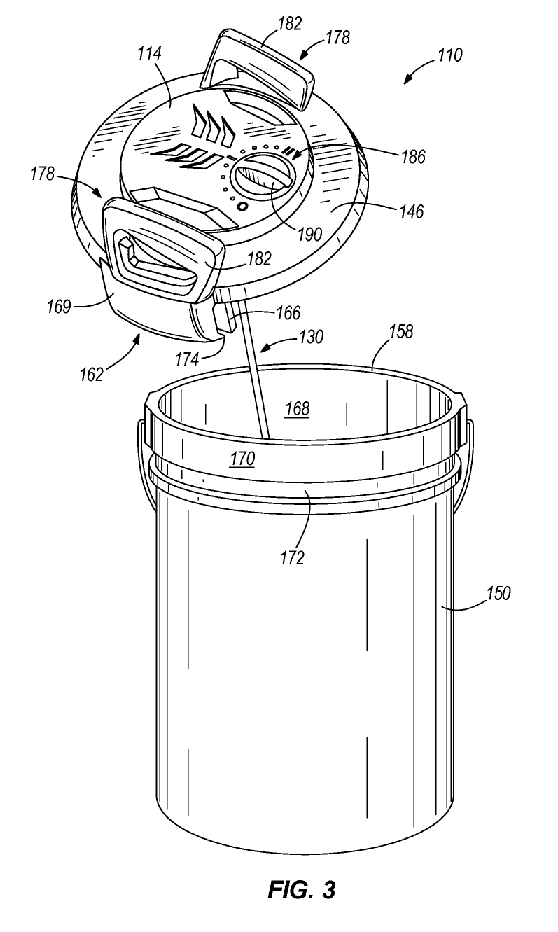

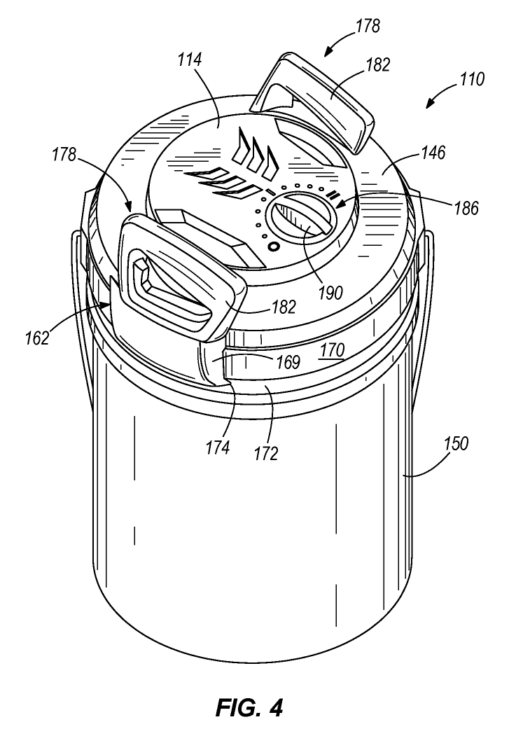

FIGS. 3 and 4 illustrate a mixing device 110 according to another construction of the invention. The mixing device 110 includes a housing 114 and a motor 118 (e.g., an electric motor; FIG. 5) supported within the housing 114. The motor 118 may receive electrical power from a remote power source via an electrical cord (not shown), or the motor may receive electrical power from an onboard power source (e.g., a battery). Should a battery be used to provide electrical power to the motor 118, the mixing device 110 may include a charging circuit within the housing 114 to recharge the battery via the cord and a remote power source (e.g., household line current). Alternatively, the motor 118 may be configured to operate using a different power source (e.g., using a pressurized gas, a pressurized fluid, etc.).

The mixing device 110 also includes an agitator 130 drivably coupled to the motor 118. More particularly, the agitator 130 is drivably coupled to the motor 118 via a gearbox or transmission 132 to decrease the rotational speed of the agitator 130 or increase the amount of torque transferred to the agitator 130. With reference to FIG. 5, the transmission 132 is configured to impart an orbital motion to the agitator 130 about a central axis 126 of the housing 114, in addition to rotating the agitator 130 about its axis 128. The transmission 132 may include a planetary arrangement or gear train to impart such orbital and rotational motion to the agitator 130. Alternatively, the transmission 132 may include any of a number of different gear train configurations to impart orbital and rotational motion to the agitator 130.

With continued reference to FIG. 5, the agitator 130 includes a shaft 134 and a plurality of blades 138 coupled to the shaft 134. The blades 138 are substantially evenly spaced on the shaft 134 to appropriate mixing depths when used, for example, on a 5-gallon container (e.g., container 150; see FIGS. 3 and 4). The blades 138 each include a pitch of about 0.375 inches to provide a mixing depth in the container 150 of about 4 inches. Alternatively, the blades 138 may include a different pitch to provide a mixing depth greater or less than 4 inches. Further, each of the blades 138 may include a different pitch to provide a varying mixing depth along the length of the agitator 130. Alternatively, the blades 138 may be configured in any of a number of different ways, with or without a pitch, to provide a particular mixing depth along the length of the agitator 130. The illustrated agitator 130 includes three blades 138. Alternatively, the agitator 130 may be configured to include a different number of blades 138.

With reference to FIG. 6, another construction of an agitator 130a includes a continuous, spiraled blade 142 having a right-handed pitch positioned above each of the mixing blades 138. In operation of the mixing device 110 with the agitator 130a, the spiraled blades 142 impart a downward movement to the mixture toward the adjacent mixing blade 138. In this manner, the portion of the mixture between the upper level of the mixture and the uppermost submerged mixing blade 138 may be thoroughly mixed. The spiraled blades 142 may include any of a number of different pitches. Alternatively, each of the spiraled blades 142 may include a different pitch to impart different amounts of downward movement to the mixture with respect to the mixture depth.

With reference to FIGS. 3 and 4, the mixing device 110 also includes a mount 146 coupled to the housing 114 to rotationally and axially secure the housing 114 to a mixture-carrying container 150. The mount 146 may be coupled to the housing 114 in any of a number of different ways (e.g., by overmolding the housing 114, by integrally forming with the housing 114, by fastening to the housing 114, etc.). The illustrated container 150 is configured as a 5-gallon, cylindrical container 150. Alternatively, the container 150 may be configured with a larger or smaller internal volume, and may contain any of a number of different mixtures (e.g., paint, drywall compound, etc.). The combination of the mount 146 and the housing 114 defines a recess or a receptacle 154 in which an open end 158 of the container 150 is received when the mixing device 110 is attached to the container 150 (FIG. 5), thereby allowing the housing 114 and mount 146 to cover or seal the open end 158 of the container 150 to substantially prevent spilling of the mixture outside of the container 150 as the mixture is stirred by the agitator 130.

With reference to FIGS. 3 and 4, the mixing device 110 also includes dual clamping mechanisms 162 operable to secure the housing 114 and the mount 146 to the open end 158 of the container 150. Each of the clamping mechanisms 162 includes a backing member 166 engageable with an interior surface 168 of the container 150, and a movable clamping member 169 engageable with an exterior surface 170 of the container 150, such that the container wall may be grasped or secured between the backing member 166 and the movable clamping member 169. Each of the backing members 166 has an arcuate or a curved shape corresponding to the curvature of the interior surface 168 of the container 150. Each of the movable clamping members 169 is integrally formed with the mount 146 and pivotable relative to the mount 146 by a living hinge (not shown). As such, each of the movable clamping members 169 is internally biased to the undeflected shape or position with respect to the backing member 166 shown in FIG. 5. Alternatively, external biasing elements (e.g., springs, etc.) may be employed to bias the movable clamping members 169 to the positions shown in FIG. 5, or a separate hinge may be coupled between the clamping members 169 and the mount 146.

The container 150 includes a circumferential groove 172 disposed proximate the open end 158 of the container. Each of the movable clamping members 169 includes an inwardly-extending distal end or tip 174 that is received within the circumferential groove 172 when the mixing device 110 is fully attached to the container 150 to axially secure the mixing device 110 to the container 150. In addition to axially securing the mixing device 110 to the container 150, each of the movable clamping members 169 is deflected radially outwardly, against the internal bias of each of the clamping members 169, when the distal end or tip 174 of each of the clamping members 169 is received within the circumferential groove 172. As a result, each of the movable clamping members 169 applies a radially inwardly-directed force or normal force to the container 150, thereby allowing a frictional force to develop between the backing member 166 and the interior surface 168 of the container 150, and between the clamping member 169 and the exterior surface 170 of the container 150 to rotationally secure the mixing device 110 with respect to the container 150.

With continued reference to FIGS. 3 and 4, the mixing device 110 also includes dual actuators 178 coupled to the respective movable clamping members 169. Each of the actuators 178 is movable between a first position, in which the movable clamping member 169 is biased to engage the exterior surface 170 of the container 150, and a second position, in which the movable clamping member 169 is disengaged from the exterior surface 170 of the container 150 against the internal bias of the clamping member 169. More particularly, the actuators 178 are configured as handles 182 integrally formed with the respective movable clamping members 169 to facilitate transport of the mixing device 110 and the container 150 as a unit. As such, to disengage the respective clamping members 169 from the exterior surface 170 of the container 150, the user of the mixing device 110 would grasp the left-side handle 182 with their left hand and the right-side handle 182 with their right hand, and pivot the handles 182 toward each other about the living hinges between the respective clamping members 169 and the mount 146. To allow the respective clamping members 169 to re-engage the exterior surface 170 of the container 150, the user of the mixing device 110 would release the handles 182 to allow the internal bias of the clamping members 169 to pivot the respective clamping members 169 toward the exterior surface 170 of the container.

With reference to FIGS. 3 and 4, the mixing device 110 also includes a timer switch 186 configured to electrically connect the motor 118 and the power source (e.g., household line current or a battery) to activate or energize the motor 118 to drive the agitator 130. The timer switch 186 includes a dial 190 that is manually positioned by the user to set the time of operation of the mixing device 110 between a predetermined minimum value (e.g., one minute) and a predetermined maximum value (e.g., 10 minutes). Any of a number of different increments of time may be employed by the timer switch 186, and any of a number of time increments may be employed by the timer switch 186.

In addition to the timer switch 186, the mixing device 110 may include a manually actuated, two-position switch or momentary switch (not shown) electrically connected in parallel with the timer switch 186 to allow a user to manually operate the agitator 130 for an indefinite period of time at a fixed or predetermined rotational speed. Alternatively, the manually-actuated switch may be configured as a variable resistor including a dial that is manually positioned by the user to set the rotational speed of the agitator between a predetermined minimum value (e.g., zero) and a predetermined maximum value.

In addition to the timer switch 186 and/or the momentary switch, the mixing device 110 may include a circuit 194 (FIG. 5) in electrical communication with the motor 118 that is configured to cycle the operation of the motor 118 (and therefore the agitator 130) according to one or more predetermined mixing cycles. Such mixing cycles may be paired with particular types of mixtures (e.g., paint, concrete, etc.) to ensure optimal mixing for each type of mixture. The circuit 194 may also include an interlock to override the cycling of the motor 118 after an initial mixing process is completed, whether based upon a timer or manual operation by a user.

To use the mixing device 110 illustrated in FIGS. 3 and 4, a user would first spread the distal ends or tips 174 of the clamping members 169 outwardly by inwardly pivoting the respective handles 182, and insert the backing members 166 into the open end 158 of the container 150. The user then releases the handles 182 and pushes the mixing device 110 downwardly until the open end 158 of the container 150 is entirely received by the receptacle 154, thereby sealing the mixture within the container 150. Subsequent to or substantially coinciding with the mount 146 enclosing the open end 158 of the container 150, the distal ends or tips 174 of the respective clamping members 169 are received within the circumferential groove 172 of the container 150, thereby allowing the clamping members 169 to snap or pivot inwardly to both axially and rotationally secure the mixing device 110 to the container 150. The mixing device 110 and the container 150 may then be carried as a unit without substantial concern of the container 150 being unintentionally released from the mixing device 110.

After the mixing device 110 is attached to the container 150, the user may energize the motor 118 to drive the agitator 130 by actuating the timer switch 186 to complete the circuit between the motor 118 and the power source (e.g., household line current or a battery). Specifically, the user would rotate the dial 190 to the particular desired operating time, and then release the dial 190 to energize the motor 118 and drive the agitator 130 to initiate stirring of the mixture. At the conclusion of the set operating time, the timer switch 186 would open circuit between the motor 118 and the power source to de-energize the motor 118 and stop the agitator 130.

In a configuration of the mixing device 110 including a manually-actuated, two-position switch in parallel with the timer switch 186 or in lieu of the timer switch 186, the user would toggle the switch to a closed position to energize the motor 118 and drive the agitator 130 to initiate stirring of the mixture. To cease stirring of the mixture, the user would toggle the two-position switch to an open position to de-energize the motor 118 and stop the agitator 130. Alternatively, in a configuration of the mixing device 110 including a manually-actuated momentary switch in parallel with the timer switch 186 or in lieu of the timer switch 186, the user would toggle or depress the momentary switch, against a spring bias, to a closed position to energize the motor 118 and drive the agitator 130 to initiate stirring of the mixture. Then, to cease stirring of the mixture, the user would release the toggle or button to allow the spring bias to return the momentary switch to an open position.

After mixing is complete, the user removes the mixing device 110 from the container 150 by grasping the respective handles 182, inwardly pivoting the handles 182 toward each other to disengage the respective clamping members 169 from the exterior surface 170 of the container 150, and pulling the mixing device 110 from the open end 158 of the container 150. After the mixing device 110 is removed from the container 150, should the user determine that the mixture require additional mixing, the user may hold or support the mixing device 110 by the respective handles 182 above the open end 158 of the container 150 and maneuver the agitator 130 within the container 150 to perform such additional mixing (FIG. 3).

The mixing device 110 also includes a vibration device 198 (FIG. 5) to facilitate removing mixture clinging to the agitator 130 after the mixing device 110 is removed from the container 150. Although the vibration device 198 is shown incorporated with the motor 118, the vibration device 198 may be a separate and distinct component from the motor 118 that is coupled to the housing 114 and that is activated separately from the motor 118. In operation of the mixing device 110 after the device 110 is removed from the container, the vibration device 198 may be activated or turned on for a period of time to vibrate the agitator 130 (without rotating the agitator 130) to shake loose any mixture clinging to the agitator 130. The device 110 may be maintained above the open end 158 of the container 150 to allow the mixture to return to the container 150. Like the motor 118, operation of the vibration device 198 may be timed or may be indefinite based upon user input. Alternatively, the vibration device 198 may be utilized while the agitator 130 is submerged in the material to facilitate removal of any air bubbles, etc. trapped in the material.

To clean the mixing device 110, the user would attach the mixing device 110 to a container of cleaning solution or solvent, having a similar size as the mixture-carrying container 150, in a similar manner as described above. The user would then actuate the timer switch 186 to energize the motor 118 and drive the agitator 130 to initiate cleaning of the agitator 130 and the portions of the housing 114 and mount 146 exposed to the open end 158 of the container 150 when the mixing device 110 is attached to the container 150 (e.g., the receptacle 154). After cleaning is complete, the user would then remove the mixing device 110 from the container of cleaning solution or solvent in the same manner as described above.

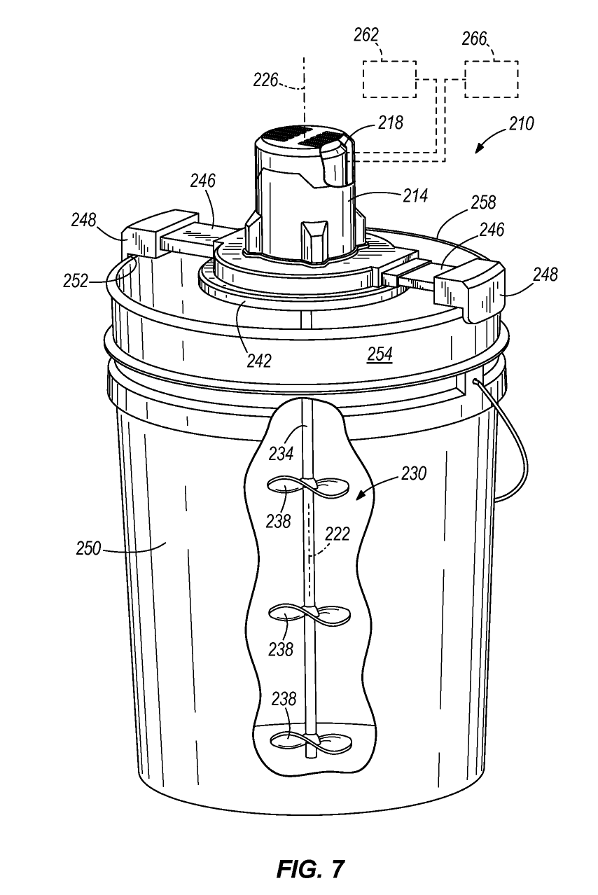

FIG. 7 illustrates a mixing device 210 according to another construction of the invention. The mixing device 210 includes a housing 214 and a motor 218 (e.g., an electric motor) supported within the housing 214. The motor 218 may receive electrical power from a remote power source via an electrical cord (not shown), or the motor 218 may receive electrical power from an onboard power source (e.g., a battery). Should a battery be used to provide electrical power to the motor 218, the mixing device 210 may include a charging circuit within the housing 214 to recharge the battery via the cord and a remote power source (e.g., household line current). Alternatively, the motor 218 may be configured to operate using a different power source (e.g., using a pressurized gas, a pressurized fluid, etc.). The motor 128 includes an output shaft (not shown) having an axis of rotation 222 coaxial with a central axis 226 of the housing 214.

The mixing device 210 also includes an agitator 230 coupled for rotation with the output shaft of the motor 218. The agitator 230 may be directly coupled to the output shaft of the motor 218 in any of a number of different ways (e.g., using fasteners, using an interference fit, etc.). Alternatively, a transmission or a gearbox may be positioned between the output shaft of the motor 218 and the agitator 230 to decrease the rotational speed of the agitator 230 or increase the amount of torque transferred to the agitator 230. Such a transmission or gearbox may be configured to position the agitator 230 in a location offset from the central axis 226 of the housing 214. Such a transmission or gearbox may also be configured to impart an orbital motion to the agitator 230, about the central axis 226 of the housing 214, in addition to rotating the agitator 230 about its axis.

The agitator 230 includes a shaft 234 and a plurality of blades 238 coupled to the shaft 234. The blades 238 are substantially evenly spaced on the shaft 234 to appropriate mixing depths when used, for example, on a typical 5-gallon container (e.g., container 250). The blades 238 each include a pitch of about 0.375 inches to provide a mixing depth in the container 250 of about 4 inches. Alternatively, the blades 238 may include a different pitch to provide a mixing depth greater or less than 4 inches. Further, each of the blades 238 may include a different pitch to provide a varying mixing depth along the length of the agitator 230. Alternatively, the blades 238 may be configured in any of a number of different ways, with or without a pitch, to provide a particular mixing depth along the length of the agitator 230. The illustrated agitator 230 includes three blades 238. Alternatively, the agitator 230 may be configured to include a different number of blades 238. As a further alternative, the agitator 230 may be configured in a similar manner to the agitator 130a shown in FIG. 6.

The mixing device 210 also includes a base 242 coupled to the housing 214 and supported above a mixture-carrying container 250. The base 242 may be coupled to the housing 214 in any of a number of different ways (e.g., by overmolding the housing 214, by integrally forming with the housing 214, by fastening to the housing 214, etc.). The illustrated container 250 is configured as a 5-gallon cylindrical container. Alternatively, the container 250 may be configured with a larger or smaller internal volume, and may contain any of a number of different mixtures (e.g., paint, drywall compound, etc.).

The mixing device 210 also includes a plurality of telescoping supports or arms 246 extending from the base 242 in a direction substantially transverse to the central axis 226 of the housing 214. Each of the telescoping arms 246 includes a mount 248 coupled to the distal end or tip of the arm 246. Each of the mounts 248 includes an inner peripheral surface 252 having a curvature defined by a radius centered on the central axis 226 of the housing 214, and that is substantially parallel with the curvature of the exterior surface 254 of the container 250. The mounts 248 may be made from an elastomeric material having a relatively high coefficient of friction to allow sufficient frictional forces to develop between the mounts 248 and the exterior surface 254 of the container 250 to both axially and rotationally secure the mixing device 210 on the container 250. Alternatively, the mounts 248 may include additional features (e.g., protrusions or lips) to more positively secure the mixing device 210 to the container 250.

Although not shown in FIG. 7, the mixing device 210 includes a switch configured to electrically connect the motor 218 and the power source (e.g., household line current or a battery) to activate or energize the motor 218 to drive the agitator 230. The switch may be configured as a manually actuated, two-position switch or momentary switch to allow a user to manually operate the agitator 230 for an indefinite period of time at a fixed or predetermined rotational speed. Alternatively, the switch may be configured as a variable resistor including a dial that is manually positioned by the user to set the rotational speed of the agitator 230 between a predetermined minimum value (e.g., zero) and a predetermined maximum value.

In addition, the mixing device 210 may include a timer switch electrically connected to the switch in a parallel arrangement to allow the user to limit the time of operation of the motor 218 and the agitator 230. For example, the timer switch may include a dial that is manually positioned by the user to set the time of operation of the mixing device 210 between a predetermined minimum value (e.g., one minute) and a predetermined maximum value (e.g., 10 minutes). Any of a number of different increments of time may be employed by the timer switch, and any of a number of time increments may be employed by the timer switch. As a further alternative, the timer switch may be employed without the two-position or momentary switch, such that the mixing device 210 may not be operated indefinitely (e.g., the timer switch 186 employed by the mixing device 110 of FIGS. 3 and 4). As yet another construction, the mixing device 210 may include a circuit 262 (FIG. 7) in electrical communication with the motor 218 that is configured to cycle the operation of the motor 218 (and therefore the agitator 230) according to one or more predetermined mixing cycles. Such mixing cycles may be paired with particular types of mixtures (e.g., paint, concrete, etc.) to ensure optimal mixing for each type of mixture. The circuit 262 may also include an interlock to override the cycling of the motor 218 after an initial mixing process is completed, whether based upon a timer or manual operation by a user.

To use the mixing device 210 illustrated in FIG. 7, a user would first extend the respective arms 246 to an appropriate length to allow the mixing device 210 to be supported on an open end 258 of the container 250 by the mounts 248. The user would then retract the respective arms 246 to engage the inner peripheral surface 252 of each of the mounts 248 with the exterior surface 254 of the container 250 to center the agitator 230 within the container 250, and to axially and rotationally secure the mixing device 210 on the container 250 as discussed above.

After the mixing device 210 is attached to the container 250, the user may energize the motor 218 to drive the agitator 230 by actuating the switch to complete the circuit between the motor 218 and the power source (e.g., household line current or a battery). In a configuration of the mixing device 210 including a two-position switch, the user would toggle the two-position switch to a closed position to energize the motor 218 and drive the agitator 230 to initiate stirring of the mixture. To cease stirring of the mixture, the user would toggle the two-position switch to an open position to de-energize the motor 218 and stop the agitator 230. Alternatively, in a configuration of the mixing device 210 including a momentary switch, the user would toggle or depress the momentary switch, against a spring bias, to a closed position to energize the motor 218 and drive the agitator 230 to initiate stirring of the mixture. Then, to cease stirring of the mixture, the user would release the toggle or button to allow the spring bias to return the momentary switch to an open position to de-energize the motor 218 and stop the agitator 230.

Further, in a configuration of the mixing device 210 including a separate timer in parallel with the manually-actuated switch or in lieu of the manually-actuated switch, the user would set the timer switch to the particular desired operating time, and then release the dial to energize the motor 218 and drive the agitator 230 to initiate stirring of the mixture. At the conclusion of the set operating time, the timer switch would open the circuit between the motor 218 and the power source to de-energize the motor 218 and stop the agitator 230.

After mixing is complete, the user removes the mixing device 210 from the container 250 by extending the respective arms 246 to disengage the respective inner peripheral services 252 of the mounts 248 from the exterior surface 254 of the container 250. The mixing device 210 may then be removed from the container 250.

The mixing device 210 also includes a vibration device 266 to facilitate removing mixture clinging to the agitator 230 after the mixing device 210 is removed from the container 250. Although the vibration device 266 is shown incorporated with the motor 218, the vibration device 266 may be a separate and distinct component from the motor 218 that is coupled to the housing 214 and that is activated separately from the motor 218. In operation of the mixing device 210 after the device 210 is removed from the container, the vibration device 266 may be activated or turned on for a period of time to vibrate the agitator 230 (without rotating the agitator 230) to shake loose any mixture clinging to the agitator 230. The device 210 may be maintained above the open end 258 of the container 250 to allow the mixture to return to the container 250. Like the motor 218, operation of the vibration device 266 may be timed or may be indefinite based upon user input. Alternatively, the vibration device 266 may be utilized while the agitator 230 is submerged in the material to facilitate removal of any air bubbles, etc. trapped in the material.

To clean the mixing device 210, the user would attach the mixing device 210 to a container of cleaning solution or solvent in a similar manner as described above. The user would then actuate the manually-actuated switch or the timer switch to energize the motor 218 and drive the agitator 230 to initiate cleaning of the agitator 230. After cleaning is complete, the user would then remove the mixing device 210 from the container of cleaning solution or solvent in the same manner as described above.

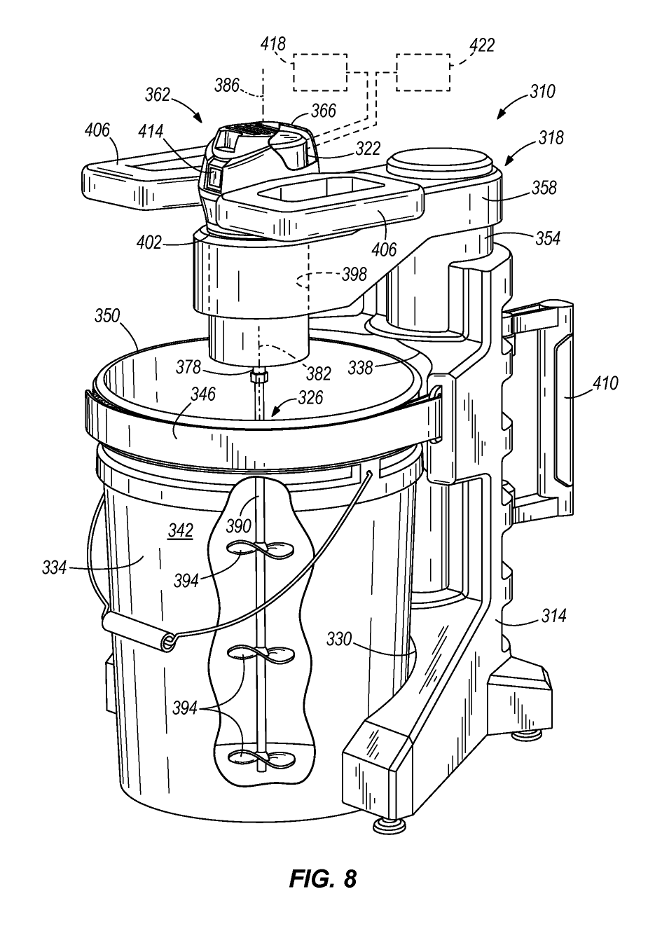

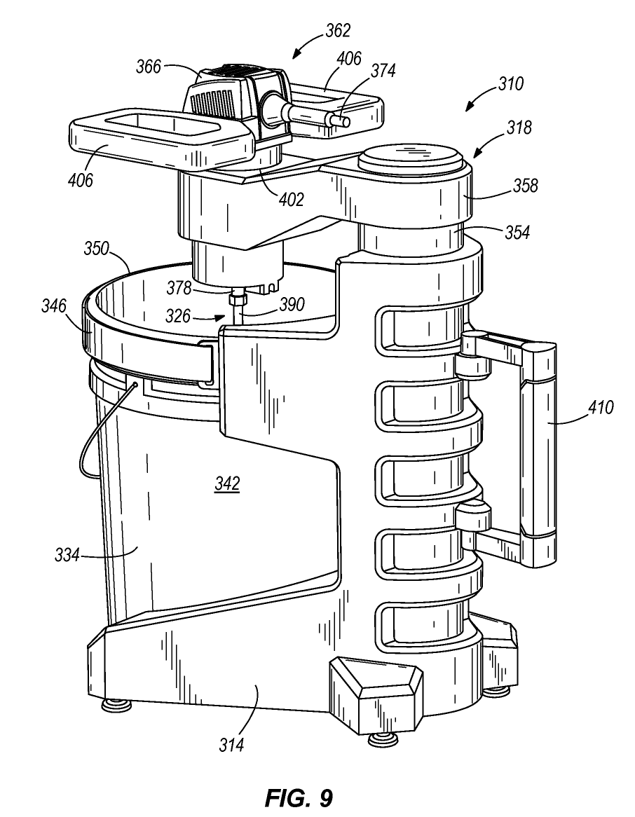

FIGS. 8 and 9 illustrate another construction of a mixing device 310 of the invention. The mixing device 310 includes a base 314, a radial arm 318 supported by the base 314, a motor 322 supported by the radial arm 318, and an agitator 326 operably coupled to the motor 322. As shown in FIG. 8, the base 314 includes a first arcuate recess 330 within which a first portion of a mixture-carrying container 334 is received, and a second arcuate recess 338 within which a second portion of the container 334 is received. The illustrated container 334 is configured as a 5-gallon container similar to the containers 150, 250 shown in FIGS. 3, 4, and 7. Each of the first and second arcuate recesses 330, 338 includes a curvature defined by a radius similar to that of an exterior surface 342 of the container 334 to allow a snug fit of the container 334 within the respective recesses 330, 338. Alternatively, the container 334 may be configured with a larger or smaller internal volume, and the first and second recesses 334, 338 may be sized having a radius of curvature substantially similar to that of the exterior surface of the particular size container.

With reference to FIG. 8, the mixing device 310 also includes a strap 346 wrapped around at least a portion of the exterior surface 342 of the container 334 to both axially and rotationally secure the container 334 within the respective arcuate recesses 330, 338 of the base 314. In the illustrated construction of the mixing device 310, the strap 346 is disposed proximate an open end 350 of the container 334. Alternatively, the strap 346 may be disposed in the middle of the container 334 or near the bottom end of the container 334. In addition, the illustrated strap 346 is formed from two pieces, each individually anchored to the base 314, interconnected by a hook and loop-style fastener (e.g., a Velcro® brand fastener). Alternatively, any of a number of different fasteners may be employed to interconnect the two-piece strap 346 (e.g., a buckle, a latch, etc.).

The radial arm 318 includes a shaft 354 supported by the base 314 and an arm 358 extending from the shaft 354 in a direction substantially transverse to the shaft 354. The shaft 354 is received within a cylindrical bore in the base 314, and is both axially and rotationally movable in the bore to allow the position of the arm 358 to be adjusted with respect to the base 314. The mixing device 310 may also include a locking mechanism (not shown) operable to selectively secure or lock the shaft 354 to the base 314 to maintain the arm 358 in a particular axial and angular position relative to the base 314.

The mixing device 310 also includes a mixing unit 362 having a housing 366 and the motor 322 (e.g., an electric motor) supported within the housing 366. The motor 322 may receive electrical power from a remote power source via an electrical cord 374 (FIG. 9), or the motor 322 may receive electrical power from an onboard power source (e.g., a battery). Should a battery be used to provide electrical power to the motor 322, the mixing unit 362 may include a charging circuit within the housing 366 to recharge the battery via the cord 374 and a remote power source (e.g., household line current). Alternatively, the motor 322 may be configured to operate using a different power source (e.g., using a pressurized gas, a pressurized fluid, etc.). The motor 322 includes an output shaft 378 having an axis of rotation 382 coaxial with a central axis 386 of the housing 366.

The agitator 326 of the mixing device 310 is coupled for rotation with the output shaft 378 of the motor 322. The agitator 326 may be coupled to the output shaft 378 in any of a number of different ways (e.g., using fasteners, using an interference fit, using a chuck or collett, etc.). Alternatively, a transmission or a gearbox may be positioned between the output shaft 378 and the agitator 326 to decrease the rotational speed of the agitator 326 or increase the amount of torque transferred to the agitator 326. Such a transmission or gearbox may be configured to position the agitator 326 in a location offset from the axis of rotation 382 of the shaft 378. Such a transmission or gearbox may also be configured to impart an orbital motion to the agitator 326, about the axis of rotation 382 of the shaft 378, in addition to rotating the agitator 326 about its axis.

With continued reference to FIG. 8, the agitator 326 includes a shaft 390 and a plurality of blades 394 coupled to the shaft 390. The blades 394 are substantially evenly spaced on the shaft 390 to appropriate mixing depths when used, for example, on a 5-gallon container (e.g., container 334). The blades 394 each include a pitch of about 0.375 inches to provide a mixing depth of about 4 inches. Alternatively, the blades 394 may include a different pitch to provide a mixing depth greater or less than 4 inches. Further, each of the blades 394 may include a different pitch to provide a varying mixing depth along the length of the agitator 326. Alternatively, the blades 394 may be configured in any of a number of different ways, with or without a pitch, to provide a particular mixing depth along the length of the agitator 326. The illustrated agitator 326 includes three blades 394. Alternatively, the agitator 326 may be configured to include a different number of blades 394. As a further alternative, the agitator 326 may be configured similar to the agitator 130a shown in FIG. 6.

The arm 358 includes an aperture 398 through which at least a portion of the housing 366 is received to support the mixing unit 362 and the agitator 326 with respect to the base 314. The housing 366 includes a flange 402 that engages the upper surface of the arm 358 to limit the extent to which the housing 368 is inserted through the aperture 398. Alternatively, the housing 366 may include any of a number of different features configured to limit the extent to which the housing 366 is inserted through the aperture 398. In addition, any of a number of different components or features may be employed to rotationally secure the housing 366 to the arm 358 when the housing 366 is positioned in the aperture 398 (e.g., a key and keyway arrangement, an interference fit, a spline fit, etc.). However, such components or features would permit the mixing unit 362 to be removed from the arm 358 and used separately without the base 314 and the radial arm 318.

The mixing unit 362 also includes a plurality of handles 406 coupled to the housing 366. As shown in FIGS. 8 and 9, each of the handles 406 is generally D-shaped, and lies in a plane oriented substantially normal to the central axis 386 of the housing 366. Alternatively, the handles 406 may be configured or shaped in any of a number of different ways, or may be oriented in a different manner as that shown in FIGS. 8 and 9. The handles 406 are also integrally formed with the housing 366. Alternatively, the handles 406 may be coupled to the housing 366 in any of a number of different ways. The mixing device 310 includes another handle 410 pivotably coupled to the base 314 to facilitate transport of the base 314, the radial arm 318, and the mixing unit 362 (if connected to the radial arm 318; FIG. 9).

With reference to FIG. 8, the mixing device 310 also includes a switch 414 configured to electrically connect the motor 322 and the power source (e.g., household line current or a battery) to activate or energize the motor 322 to drive the agitator 326. The switch 414 may be configured as a manually actuated, two-position switch or momentary switch to allow a user to manually operate the agitator 326 for an indefinite period of time at a fixed or predetermined rotational speed. Alternatively, the switch 414 may be configured as a variable resistor including a dial that is manually positioned by the user to set the rotational speed of the agitator 326 between a predetermined minimum value (e.g., zero) and a predetermined maximum value.

In addition, the mixing device 310 may include a timer switch electrically connected to the switch 414 in a parallel arrangement to allow the user to limit the time of operation of the motor 322 and the agitator 326. For example, the timer switch may include a dial that is manually positioned by the user to set the time of operation of the mixing device 310 between a predetermined minimum value (e.g., one minute) and a predetermined maximum value (e.g., 10 minutes). Any of a number of different increments of time may be employed by the timer switch, and any of a number of time increments may be employed by the timer switch. As a further alternative, the timer switch may be employed without the switch 414, such that the mixing device 310 may not be operated indefinitely. As yet another alternative, the mixing device 310 may include a circuit 418 (FIG. 8) in electrical communication with the motor 322 that is configured to cycle the operation of the motor 322 (and therefore the agitator 326) according to one or more predetermined mixing cycles. Such mixing cycles may be paired with particular types of mixtures (e.g., paint, concrete, etc.) to ensure optimal mixing for each type of mixture. The circuit 418 may also include an interlock to override the cycling of the motor 322 after an initial mixing process is completed, whether based upon a timer or manual operation by a user.

To use the mixing device 310 illustrated in FIGS. 8 and 9, a user would first position the mixture-carrying container 334 within the respective recesses 330, 338 in the base 314 and secure the container 334 to the base 314 using the strap 346. The user then inserts the mixing unit 362 with attached agitator 326 through the aperture 398 in the arm 358 and submerges the agitator 326 within the mixture in the container 334 until the flange 402 on the housing 366 engages the upper surface of the arm 358. The radial arm 318 is then adjusted relative to the base 314 to center the agitator 326 within the container 334 and to position the agitator 326 at an appropriate height with respect to the upper level of the mixture in the container 334. After the agitator 326 is adjusted to its final mixing position, the user actuates the locking mechanism between the shaft 354 and the base 314 to both axially and rotationally secure the radial arm 318, and therefore the agitator 326, relative to the base 314.

The user then energizes the motor 322 to drive the agitator 326 by actuating the switch 414 to complete the circuit between the motor 322 and the power source (e.g., household line current or a battery). In a configuration of the mixing device 310 including a two-position switch, the user would toggle the two-position switch to a closed position to energize the motor 322 and drive the agitator 326 to initiate stirring of the mixture. To cease stirring of the mixture, the user would toggle the two-position switch to an open position to de-energize the motor 322 and stop the agitator 326. Alternatively, in a configuration of the mixing device 310 including a momentary switch, the user would toggle or depress the momentary switch, against a spring bias, to a closed position to energize the motor 322 and drive the agitator 326 to initiate stirring of the mixture. Then, to cease stirring of the mixture, the user would release the toggle or button to allow the spring bias to return the momentary switch to an open position to de-energize the motor 322 and stop the agitator 326.

Further, in a configuration of the mixing device 310 including a separate timer switch in parallel with the switch 414 or in lieu of the switch 414, the user would set the dial of the timer switch to the particular desired operating time, and then release the dial to energize the motor 322 and drive the agitator 326 to initiate stirring of the mixture. At the conclusion of the set operating time, the timer switch would open the circuit between the motor 322 and the power source to de-energize the motor 322 and stop the agitator 326.

After mixing is complete, the user removes the agitator 326 from the container 334 by unlocking the shaft 354 from the base 314, and raising the radial arm 318. After the agitator 326 is removed from the container 334, should the user determine that the mixture requires additional or finishing mixing, the user may remove the mixing unit 362 from the radial arm 318 and support the mixing unit 362 by the respective handles 406 above the open end 350 of the container 334 and maneuver the agitator 326 within the container 334 to perform such additional or finishing mixing.

The mixing device 310 also includes a vibration device 422 (FIG. 8) to facilitate removing mixture clinging to the agitator 326 after the agitator 326 is removed from the container 334. Although the vibration device 422 is shown incorporated with the motor 322, the vibration device 422 may be a separate and distinct component from the motor 322 that is coupled to the housing 366 and that is activated separately from the motor 322. In operation of the mixing device 310 after the agitator 326 is removed from the container 334, the vibration device 422 may be activated or turned on for a period of time to vibrate the agitator 326 (without rotating the agitator 326) to shake loose any mixture clinging to the agitator 326. The agitator 326 may be maintained above the open end 350 of the container 334 to allow the mixture to return to the container 334. Like the motor 322, operation of the vibration device 422 may be timed or may be indefinite based upon user input. Alternatively, the vibration device 422 may be utilized while the agitator 326 is submerged in the material to facilitate removal of any air bubbles, etc. trapped in the material.

To clean the mixing device 310, the user would first remove the mixture-carrying container 334 from the respective recesses 330, 338 in the base 314 by separating the two-piece strap 346, and then secure a container of cleaning solution or solvent to the base 314 in a similar manner as described above. The user would then lower the radial arm 318 to submerge the agitator 326, and actuate the switch 414 or the timer switch to energize the motor 322 and drive the agitator 326 to initiate cleaning of the agitator 326. After cleaning is complete, the user would then remove the agitator 326 from the container of cleaning solution or solvent in the same manner as described above.

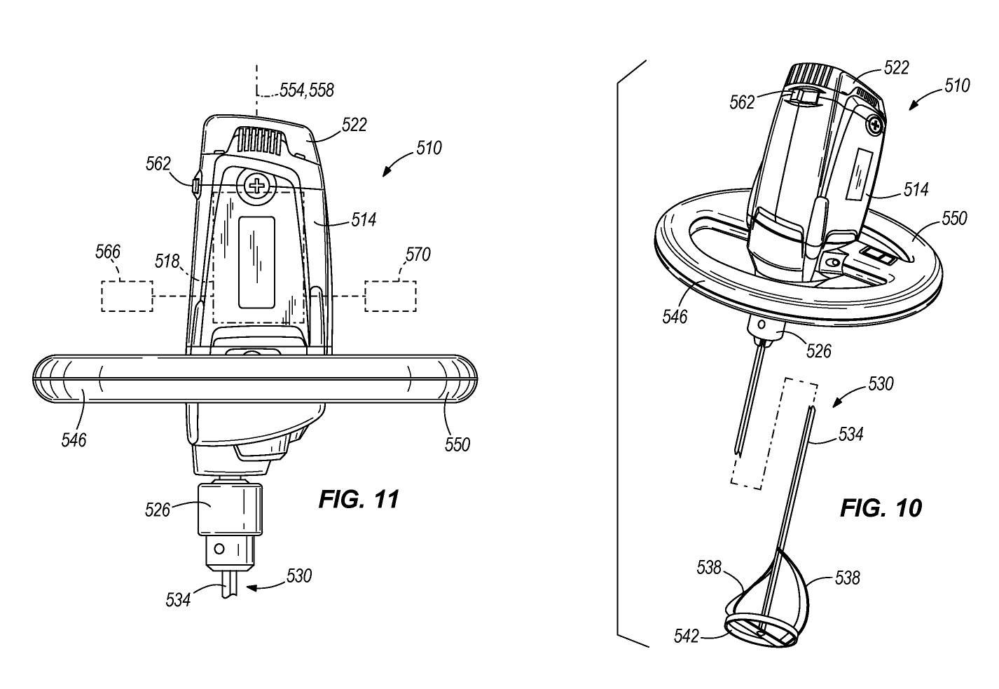

FIGS. 10 and 11 illustrate yet another construction of a mixing device 510 of the invention. The mixing device 510 includes a housing 514 and a motor 518 (e.g., an electric motor; FIG. 11) supported within the housing 514. The motor 518 receives electrical power from an onboard power source (e.g., a battery 522). The mixing device 510 may include a charging circuit within the housing 514 to recharge the battery 522 via an electrical cord and a remote power source (e.g., household line current). Alternatively, the mixing device 510 may not include the battery 522, and the mixing device 510 may receive electrical power from a remote power source via the electrical cord (not shown). Alternatively, the motor 518 may be configured to operate using a different power source (e.g., using a pressurized gas, a pressurized fluid, etc.).

With reference to FIG. 11, the mixing device 510 includes a chuck 526 drivably coupled to the motor 518, and an agitator 530 coupled for rotation with the chuck 526. The agitator 530 may be secured to the chuck 526 in a manner similar to how drill bits are secured to conventional hand drills. The mixing device 510 may also include a gearbox or transmission positioned between the motor 518 and the chuck 526 to decrease the rotational speed of the agitator 530 or increase the amount of torque transferred to the agitator 530. Such a transmission may include a planetary arrangement or gear train configured in a similar manner as those found in conventional hand drills. Alternatively, the transmission may include any of a number of different gear train configurations.

With reference to FIG. 10, the agitator 530 includes a shaft 534, a plurality of blades 538 extending from the shaft 534, and a hoop 542 coupled to the shaft 534 to provide support to the blades 538. The illustrated agitator 530 includes two blades 538. Alternatively, the agitator 530 may be configured in any of a number of different ways, and may include a different number of blades 538 extending from the shaft 534. For example, the agitator 530 may be configured in a similar manner as the agitators 130, 130a shown in FIGS. 5 and 6.

The mixing device 510 includes a first arcuate handle portion 546 coupled to a first side of the housing 514, and a second arcuate handle portion 550 coupled to a second side of the housing 514 opposite the first handle portion 546. Each of the arcuate handle portions 546, 550 includes a curvature defined by a radius centered on a central axis 554 of the housing 514. The first and second handle portions 546, 550 are interconnected as a substantially continuous, circular loop having a central axis 558 coaxial with the central axis 554 of the housing 514. Alternatively, the handle portions 546, 550 may include any of a number of different shapes (rectangular, D-shaped, etc.).

With reference to FIGS. 10 and 11, the mixing device 510 also includes a switch 562 configured to electrically connect the motor 518 and the battery 522 to activate or energize the motor 518 to drive the agitator 530. The switch 562 may be configured as a manually actuated, two-position switch or momentary switch to allow a user to manually operate the agitator 530 for an indefinite period of time at a fixed or predetermined rotational speed. Alternatively, the switch 562 may be configured as a variable resistor including a dial that is manually positioned by the user to set the rotational speed of the agitator 530 between a predetermined minimum value (e.g., zero) and a predetermined maximum value. The switch 562 may be positioned in any of a number of different locations on the housing 514 or on either of the first or second handle portions 546, 550 (e.g., either of the locations shown in FIG. 10).

In addition, the mixing device 510 may include a timer switch electrically connected to the switch 562 in a parallel arrangement to allow the user to limit the time of operation of the motor 518 and the agitator 530. For example, the timer switch may include a dial that is manually positioned by the user to set the time of operation of the mixing device 510 between a predetermined minimum value (e.g., one minute) and a predetermined maximum value (e.g., 10 minutes). Any of a number of different increments of time may be employed by the timer switch, and any of a number of time increments may be employed by the timer switch. As a further alternative, the timer switch may be employed without the switch 562, such that the mixing device 510 may not be operated indefinitely. As yet another alternative, the mixing device 510 may include a circuit 566 (FIG. 11) in electrical communication with the motor 518 that is configured to cycle the operation of the motor 518 (and therefore the agitator 530) according to one or more predetermined mixing cycles. Such mixing cycles may be paired with particular types of mixtures (e.g., paint, concrete, etc.) to ensure optimal mixing for each type of mixture. The circuit 566 may also include an interlock to override the cycling of the motor 518 after an initial mixing process is completed, whether based upon a timer or manual operation by a user.

To use the mixing device 510 illustrated in FIGS. 10 and 11, a user would first secure the agitator 530 to the chuck 526 in a manner similar to that used to attach drill bits to a conventional hand drill, and then submerge the agitator 530 into a mixture in a container (e.g., containers 50, 150 of FIGS. 1-4). The user then energizes the motor 518 to drive the agitator 530 by actuating the switch 562 to complete the circuit between the motor 518 and the battery 522. In a configuration of the mixing device 510 including a two-position switch, the user would toggle the two-position switch to a closed position to energize the motor 518 and drive the agitator 530 to initiate stirring of the mixture. To cease stirring of the mixture, the user would toggle the two-position switch to an open position to de-energize the motor 518 and stop the agitator 530. Alternatively, in a configuration of the mixing device 510 including a momentary switch, the user would toggle or depress the momentary switch, against a spring bias, to a closed position to energize the motor 518 and drive the agitator 530 to initiate stirring of the mixture. Then, to cease stirring of the mixture, the user releases the toggle or button to allow the spring bias to return the momentary switch to an open position to de-energize the motor 518 and stop the agitator 530.

Further, in a configuration of the mixing device 510 including a separate timer switch in parallel with the switch 562 or in lieu of the switch 562, the user would set the dial of the timer switch to the particular desired operating time, and then release the dial to energize the motor 518 and drive the agitator 530 to initiate stirring of the mixture. At the conclusion of the set operating time, the timer switch would open the circuit between the motor 518 and the power source to de-energize the motor 518 and stop the agitator 530.

By providing the first and second handle portions 546, 550 as a substantially continuous, circular loop having its central axis 558 coaxial with the axis of rotation 554 of the agitator 530, the user is able to support the mixing device 510 above the mixture-carrying container in a substantially ergonomic manner and exert an increased amount of control over the agitator 530 as it stirs the mixture.

After mixing is complete, the user removes the agitator 530 from the mixture in the container. The mixing device 510 also includes a vibration device 570 (FIG. 11) to facilitate removing mixture clinging to the agitator 530 after the agitator 530 is removed from the container. Although the vibration device 570 is shown incorporated with the motor 518, the vibration device 570 may be a separate and distinct component from the motor 518 that is coupled to the housing 514 and that is activated separately from the motor 518. In operation of the mixing device 510 after the agitator 530 is removed from the container, the vibration device 570 may be activated or turned on for a period of time to vibrate the agitator 530 (without rotating the agitator 530) to shake loose any mixture clinging to the agitator 530. The agitator 530 may be maintained above the open end of the container to allow the mixture to return to the container. Like the motor 518, operation of the vibration device 570 may be timed or may be indefinite based upon user input. Alternatively, the vibration device 570 may be utilized while the agitator 530 is submerged in the material to facilitate removal of any air bubbles, etc. trapped in the material.

The agitator 530 may be subsequently cleaned by submerging the agitator 530 in cleaning solution or solvent. The user then actuates the switch 562 or the timer switch to energize the motor 518 and drive the agitator 530 to initiate cleaning of the agitator 530. After cleaning is complete, the user then removes the agitator 530 from the cleaning solution or solvent.

Although particular constructions embodying independent aspects of the present invention have been shown and described, other alternative constructions will become apparent to those skilled in the art and are intended scope of the independent aspects of the invention. Various features of the invention are set forth in the following claims.

What is claimed is:

1. A mixing device for use with a container, the mixing device comprising:
a housing;
a motor supported by the housing;
an agitator operably coupled to the motor;
a clamping mechanism operable to secure the housing to an open end of the container, the clamping mechanism including
a backing member engageable with an interior surface of the container, and
a movable clamping member engageable with an exterior surface of the container, such that a wall of the container is securable between the backing member and the movable clamping member; and
an actuator coupled to the housing and movable between a first position in which the movable clamping member is biased to engage the exterior surface of the container, and a second position in which the movable clamping member is disengaged from the exterior surface of the container against the bias of the clamping member.

2. The mixing device of claim 1, wherein the actuator is configured as a handle to facilitate transport of the mixing device and the container as a unit.

3. The mixing device of claim 1, wherein the clamping mechanism is a first clamping mechanism, and wherein the mixing device further includes a second clamping mechanism opposite the first clamping mechanism relative to the housing.

4. The mixing device of claim 1, further comprising a mount coupled to the housing, wherein the mount and the housing at least partially define a receptacle in which the open end of the container is received when the clamping mechanism is engaged with the container.

5. The mixing device of claim 4, wherein the mount includes the clamping mechanism.

6. The mixing device of claim 1, further comprising a transmission coupling the agitator to the motor, wherein the transmission is operable to impart an orbital motion to the agitator about a central axis of the housing, and wherein the transmission is operable to rotate the agitator about a central axis of the agitator.

7. The mixing device of claim 1, wherein the container includes a circumferential groove disposed proximate the open end of the container, and wherein the clamping member includes a tip received within the circumferential groove to axially secure the mixing device to the container.

8. The mixing device of claim 1, further comprising a timer switch electrically connected to the motor.

9. The mixing device of claim 1, further comprising a vibration device operably coupled to the agitator.

10. A mixing device for use with a container, the mixing device comprising:
a housing;
a motor supported by the housing;
an agitator operably coupled to the motor; and
at least one telescoping support with which the housing is positioned above an open end of the container.

11. The mixing device of claim 10, wherein the at least one telescoping support is a first telescoping support, and wherein the mixing device further includes a second telescoping support opposite the first telescoping support relative to the housing to facilitate centering of the agitator in the container.

12. The mixing device of claim 10, further comprising a mount coupled to a distal end of the support, wherein the mount includes an inner peripheral surface having a curvature defined by a radius centered on a central axis of the housing, and wherein the inner peripheral surface of the mount is frictionally engageable with an outer peripheral surface of the container to secure the mixing device to the container.

13. The mixing device of claim 10, further comprising a vibration device operably coupled to the agitator.

14. A mixing device for use with a container, the mixing device comprising:
a base including an arcuate recess within which a portion of the container is received;
a radial arm supported by the base;
a motor supported by the radial arm;
an agitator operably coupled to the motor; and
a strap wrapped about at least a portion of the outer periphery of the container to secure the container within the arcuate recess of the base.

15. The mixing device of claim 14, wherein the radial arm includes
a shaft supported by the base, and
an arm extending from the shaft in a direction substantially transverse to the shaft, wherein the motor is coupled to the arm.

16. The mixing device of claim 15, wherein the shaft is both axially and rotationally movable relative to the base.

17. The mixing device of claim 14, further comprising a mixing unit including the motor and the agitator, wherein the mixing unit is removably coupled to the radial arm.

18. The mixing device of claim 17, wherein the mixing unit further includes a housing in which the motor is supported, wherein the radial arm includes an aperture in which the housing is at least partially received.

19. The mixing device of claim 18, wherein the mixing unit further includes at least one handle coupled to the housing.

20. The mixing device of claim 14, further comprising a vibration device operably coupled to the agitator.
